(19) United States
(12) Patent Application Publication
(10) Pub. No.: US 2010/0279143 A1
(43) Pub. Date: Nov. 4, 2010

(54) MULTI-ALLOY COMPOSITE SHEET FOR AUTOMOTIVE PANELS

(76) Inventors: Rajeev G. KAMAT, Murrysville, PA (US); John F. BUTLER, JR., Lititz, PA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 12/768,429

(22) Filed: Apr. 27, 2010

Related U.S. Application Data
(60) Provisional application No. 61/174,324, filed on Apr. 30, 2009.

(51) Int. Cl. B32B 15/01; B23K 20/04; B22D 19/00

(52) U.S. Cl. 428/615; 228/115; 164/91

(57) ABSTRACT

Multi-alloy composite sheets and methods of producing the composite sheets for use in automotive applications are disclosed. The automotive application may include an automotive panel having a bi-layer or a tri-layer composite sheet with 3xxx and 6xxx aluminum alloys. The composite sheets may be produced by roll bonding or multi-alloy casting, among other techniques. Each of the composite sheets may demonstrate good flat hem rating and mechanical properties, long shelf life, and high dent resistance, among other properties.

### CROSS REFERENCE TO RELATED APPLICATIONS

This application claims priority to U.S. Provisional Patent Application Ser. No. 61/174,324 filed Apr. 30, 2009, which is incorporated herein by reference in its entirety.

### BACKGROUND

Automotive panels generally include an outer panel and an inner panel. These outer and inner panels must achieve certain properties. For example, an outer panel generally must meet adequate flat hem rating, after paint-bake strength for dent resistance, class A painted surface quality, and overall good formability, among other factors. Another highly desirable aspect for hemming performance is that the material be immune to natural aging. For an inner panel, it generally must meet typically higher formability measured by adequate limiting dome height or limiting draw ratio.

### SUMMARY

Automotive panels fabricated of a multi-alloy composite sheet and method of producing the same are disclosed. In one embodiment, a multi-alloy composite sheet includes an Al—Mg—Si alloy layer and an Al—Mn alloy layer coupled to at least one surface of the Al—Mg—Si alloy layer. In some embodiments, the resulting composite sheet is capable of achieving a flat hem rating of not worse than 3, or not worse than 2, or not worse than 1.

In one embodiment, the Al—Mg—Si alloy is a 6xxx series aluminum alloy and the Al—Mn alloy is a 3xxx series aluminum alloy. In another embodiment, the Al—Mg—Si alloy layer has a thickness in the range of from about 60% to about 90% of the total thickness of the composite sheet, while the Al—Mn alloy layer has a thickness in the range of from about 10% to about 40% of the total thickness of the composite sheet.

In some embodiments, the flat hem rating is measured at a pre-strain level of at least about 1%, or at least about 7%, or at least about 11%, or at least about 15%. In other embodiments, the flat hem rating is measured at a time period of at least about 7 days, or at least about 14 days, or at least about 30 days, or at least about 60 days, or at least about 90 days.

In some embodiments, the composite sheet is capable of achieving a yield strength of at least about 190 MPa after a paint bake cycle, or at least about 210 MPa, or at least about 230 MPa. In other embodiments, the composite sheet is capable of achieving a limiting dome height of at least about 20 mm, or at least about 22 mm, or at least about 24 mm.

In one embodiment, a multi-alloy composite sheet includes an Al—Mg—Si alloy layer and two Al—Mn alloy layers where the first Al—Mn alloy layer is coupled to one surface of the Al—Mg—Si alloy layer and the second Al—Mn alloy layer is coupled to another surface of the Al—Mg—Si alloy layer, the two surfaces being opposite each other. The resulting composite sheet is capable of achieving a flat hem rating of not worse than 3, or not worse than 2, or not worse than 1.

In one embodiment, the Al—Mg—Si alloy is a 6xxx series aluminum alloy and each of the two Al—Mn alloys is a 3xxx series aluminum alloy. In another embodiment, the Al—Mg—Si alloy layer has a thickness in the range of from about 50% to about 80% of the total thickness of the composite sheet, the first Al—Mn alloy layer has a thickness in the range of from about 10% to about 40% of the total thickness of the composite sheet, and the second Al—Mn alloy layer has a thickness in the range of from about 0% to about 10% of the total thickness of the composite sheet.

In some embodiments, the flat hem rating is measured at a pre-strain level of at least about 1%, or at least about 7%, or at least about 11%, or at least about 15%. In other embodiments, the flat hem rating is measured at a time period of at least about 7 days, or at least about 14 days, or at least about 30 days, or at least about 60 days, or at least about 90 days. In one embodiment, the composite sheet is capable of achieving a yield strength of at least about 190 MPa after a paint bake cycle.

In one embodiment, a method of producing at least a bi-layer composite sheet includes producing an Al—Mg—Si alloy layer, an Al—Mn alloy layer, and placing the two alloy layers in physical contact with each other such that the resulting composite sheet achieves a flat hem rating of not worse than 3, or not worse than 2, or not worse than 1. In some embodiments, the method of producing the composite may be carried out by at least one of roll bonding, multi-alloy casting and direct chill casting. In other embodiments, the Al—Mg—Si alloy is a 6xxx series aluminum alloy and the Al—Mn alloy is a 3xxx series aluminum alloy.

In another embodiment, a method of producing at least a tri-layer composite sheet includes producing a second Al—Mn alloy layer in addition to the first Al—Mn alloy layer from above, and placing the second Al—Mn alloy layer in physical contact with a surface of the Al—Mg—Si alloy layer opposite that of the first Al—Mn alloy layer. The resulting tri-layer composite sheet is capable of achieving a flat hem rating of not worse than 3, or not worse than 2, or not worse than 1. Like above, in some embodiments, the method of producing the tri-layer composite sheet includes at least one of roll bonding, multi-alloy casting and direct chill casting. Furthermore, the second Al—Mn alloy, like the first Al—Mn alloy, may also be a 3xxx series aluminum alloy.

Other variations, embodiments and features of the present disclosure will become evident from the following detailed description, drawings and claims.

### BRIEF DESCRIPTION OF THE DRAWINGS

FIG. 1 shows an exploded view of an automotive body.

FIG. 2 shows an exploded view of a car hood.

FIG. 3 shows cross-section views of composite sheets with various range of thicknesses and layer percentages.

FIG. 4 is a process flow diagram showing the various steps of producing a composite sheet according to one embodiment of the present disclosure.

FIG. 5 is a process flow diagram showing the various steps of producing a composite sheet according to one embodiment of the present disclosure.

FIG. 6 is a process flow of a hemming process.

FIG. 7 shows cross-sectional views of different types of hemming.

FIG. 8 illustrates standards for determining flat hem ratings of test specimens.

FIG. 9 shows optical micrographs of hemming test specimens.

FIG. 10 is a dog-boned shaped standard tensile test specimen.

FIG. 11 is a process flow diagram showing the various steps of manufacturing a composite sheet according to one embodiment of the present disclosure.

FIG. 12 illustrates cross-sectional optical micrographs of hemming sites for a 6xxx aluminum alloy after 3 months natural aging.

FIG. 13 illustrates cross-sectional optical micrographs of hemming sites for a tri-layer composite sheet according to one embodiment of the present disclosure after 3 months natural aging.

### DETAILED DESCRIPTION OF THE DISCLOSURE

It will be appreciated by those of ordinary skill in the art that the embodiments disclosed herein can be embodied in other specific forms without departing from the spirit or essential character thereof. The presently disclosed embodiments are therefore considered in all respects to be illustrative and not restrictive.

Multi-alloy composite sheets and methods of producing the same for automotive applications are disclosed. In general, the multi-alloy composite sheets are capable of achieving enhanced attributes over current products on the market. Specifically, the presently disclosed multi-alloy composite sheets may demonstrate better hem performance, longer shelf life, higher after paint-bake strength, better painted surface quality, higher formability and better corrosion resistance, among other characteristics.

The instant application relates to automotive panels generally having an outer panel and an inner panel, where each of the outer panel and the inner panel is capable of achieving certain properties. In one embodiment, each of the outer panel and the inner panel may be formed of a multi-alloy composite sheet.

As used herein, “panel” means a sheet that forms a distinct, sometimes flat, section or component of something. As used herein, “sheet” means an artifact that is thin relative to its length and width. Examples of sheets include panels, such as automotive panels, which may be in the form of composite sheets. As used herein, “automotive panel” means a panel for automotive applications including the likes of hoods, fenders, doors, roofs, and trunk lids, among others.

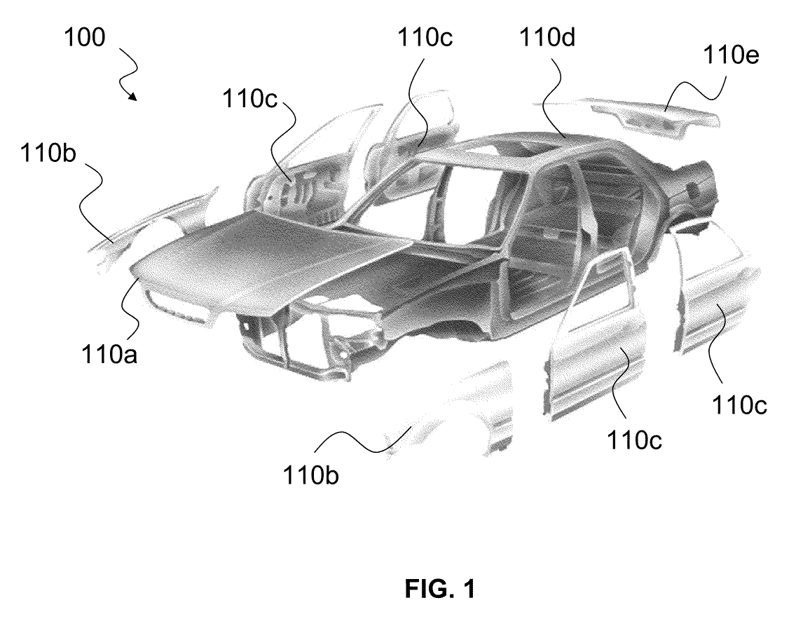

Reference is now made to FIG. 1 showing an exploded view of an automotive body 100 having a plurality of automotive panels 110. In one embodiment, an automotive panel 110 includes the likes of car hoods 110a, car fenders 110b, car doors 110c, car roofs 110d, and trunk lids 110e, among others. In some embodiments, an automotive panel 110 may include closure panels and fender liners, among other parts of an automobile. In general, an automotive panel 110 may form a distinct portion of an automobile.

In one embodiment, an automotive panel 110 includes an outer panel and an inner panel. The outer panel includes, in one embodiment, at least one composite sheet, as described further below. Similarly, in another embodiment, an inner panel may also include at least one composite sheet, where the composite sheet of the inner panel need not be the same as the composite sheet of the outer panel. Generally speaking, an outer panel is the portion of an automotive panel 110 that is intended to be exposed to outdoor conditions, while an inner panel is the portion of an automotive panel 110 that is not intended to be exposed to outdoor conditions.

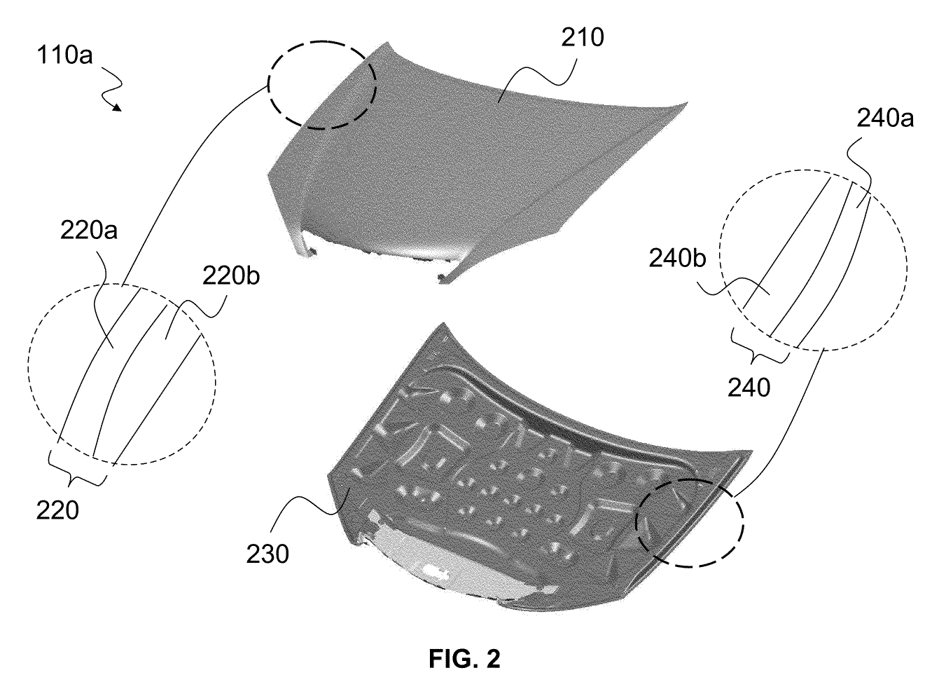

Reference is now made to FIG. 2 showing an exploded view of a car hood 110a having an outer panel 210 and an inner panel 230. An inset of the outer panel 210 shows a cross-sectional view of the outer panel 210 having a first composite sheet 220, the first composite sheet 220 having a first outer layer 220a and a first inner layer 220b. Likewise, an inset of the inner panel 230 shows a cross-sectional view of the inner panel 230 having a second composite sheet 240, the second composite sheet 240 having a second outer layer 240a and a second inner layer 240b. In some instances, the outer layers 220a, 240a may be referred to as skins or skin layers, while the inner layers 220b, 240b may be referred to as cores or core layers.

As used herein, “composite sheet” means a sheet having at least two distinct layers, such as an inner layer (e.g., core layer) and an outer layer (e.g., skin layer). For example, an automotive panel may include a composite sheet 220, 240 having at least an outer layer 220a, 240a and an inner layer 220b, 240b, where the outer layer 220a, 240a is fabricated of a first material (e.g., a first aluminum alloy) and the inner layer 220b, 240b is fabricated of a second material (e.g., a second aluminum alloy). The layers 220a, 220b, 240a, 240b of the composite sheet 220, 240 may be produced via multi-alloy casting, direct chill (DC) casting, and roll bonding, among other suitable techniques. In some embodiments, the outer layer 220a, 240a and the inner layer 220b, 240b may be coupled to each other via metallurgical bonding.

Like the outer and inner automotive panels, an outer layer of a composite sheet means a layer generally intended to be exposed to outdoor conditions while an inner layer of a composite sheet means a layer generally not intended to be exposed to outdoor conditions. In some instances, the outer layer may be referred to as a skin material while an inner layer may be referred to as a core material, such as when in use in an automotive panel.

In one embodiment, an Al—Mg—Si alloy may be suitable as an outer layer 220a, 240a of a composite sheet 220, 240. In one embodiment, an Al—Mg—Si alloy may be suitable as an inner layer 220b, 240b of a composite sheet 220, 240. As used herein, “Al—Mg—Si alloy” means an aluminum alloy having magnesium and silicon as primary alloying constituents. In some instances, the Al—Mg—Si alloy may also contain alloying additions including copper, chromium, titanium, manganese, zinc, iron, silicon and vanadium, among others.

In one embodiment, the Al—Mg—Si alloy is AA6013. As used herein, “AA6013” means Aluminum Association alloy 6013, as defined by the Aluminum Association Teal Sheets. Examples of Al—Mg—Si alloys include any of the 6xxx series alloys including at least one of AA6022, AA6111, AA6061, AA6063, AA6016, AA6056, AA6082, AA6181 and AA6181A, among others, as defined by the Aluminum Association Teal Sheets.

In one embodiment, an Al—Mn alloy may be suitable as an outer layer 220a, 240a of a composite sheet 220, 240. In one embodiment, an Al—Mn alloy may be suitable as an inner layer 220b, 240b of a composite sheet 220, 240. In some embodiments, an Al—Mn alloy may be suitable as both outer layer 220a, 240a and inner layer 220b, 240b of a composite sheet 220, 240. In other words, a composite sheet may include at least three distinct layers with a first Al—Mn alloy as an outer layer and a second Al—Mn alloy as an inner layer, the two Al—Mn alloy layers coupled on opposite surfaces of an Al—Mg—Si alloy layer. The two Al—Mn alloy layers may have the same or different compositions.

In other embodiments, a composite sheet may include multiple distinct layers with various combinations of Al—Mg—Si and Al—Mn alloys. As used herein, “Al—Mn alloy” means an aluminum alloy having manganese as a primary alloying constituent. In some embodiments, the Al—Mn alloy may also contain alloying additions including manganese, copper, chromium, iron, silicon and titanium, among others.

In one embodiment, the Al—Mn alloy is AA3104. As used herein, “AA3104” means Aluminum Association alloy 3104, as defined by the Aluminum Association Teal Sheets. In another embodiment, the Al—Mn alloy is AA3003. As used herein, “AA3003” means Aluminum Association alloy 3003, as defined by the Aluminum Association Teal Sheets. Examples of Al—Mn alloys include any of the 3xxx series alloys including at least one of AA3004 and AA3005, among others, as defined by the Aluminum Association Teal Sheets.

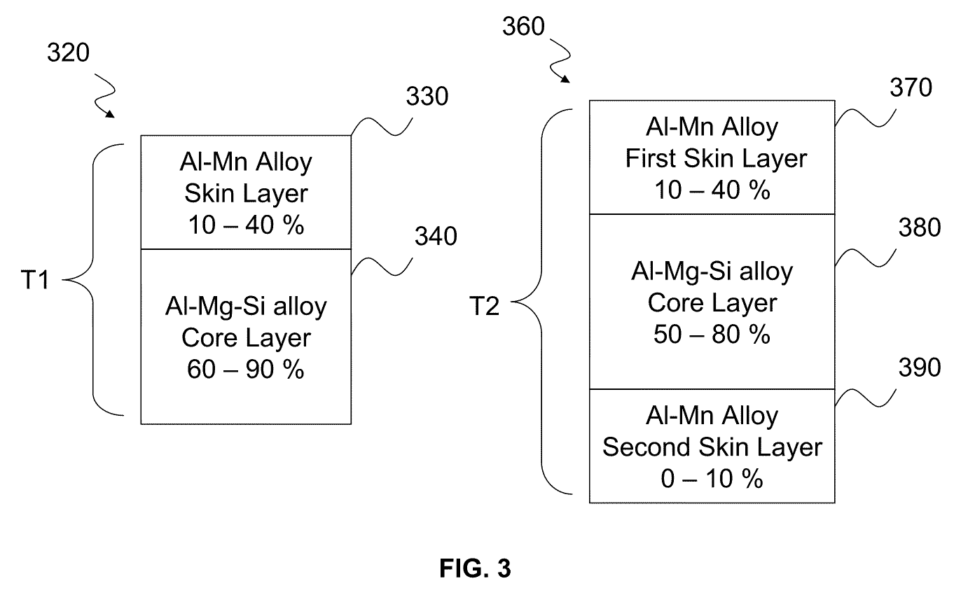

Reference is now made to FIG. 3 showing cross-sectional views of composite sheets 320, 360 with various ranges of thicknesses and layer percentages. As shown, in one embodiment, a composite sheet 320 includes an Al—Mg—Si alloy core layer 340 coupled to an Al—Mn alloy skin layer 330. As described above, the layers 330, 340 may be coupled to each other by at least one of roll bonding, multi-alloy casting and direct chill casting. In one example, the Al—Mg—Si alloy core layer 340 may be AA6013 and the Al—Mn alloy skin layer 330 may be AA3003. Alternatively, the Al—Mg—Si alloy core layer 340 may be AA6013 and the Al—Mn alloy skin layer 330 may be AA3104. In some instances, the Al—Mg—Si alloy core layer 340 includes one of 6xxx series aluminum alloys and the Al—Mn alloy skin layer 330 includes one of 3xxx series aluminum alloys.

Also shown, in one embodiment, a composite sheet 360 includes a first Al—Mn alloy skin layer 370 coupled to a first surface of an Al—Mg—Si alloy core layer 380, and a second Al—Mn alloy skin layer 390 coupled to a second surface of the Al—Mg—Si alloy core layer 380, where the first surface is opposite the second surface. Like above, the layers 370, 380, 390 may be coupled to each other by at least one of roll bonding, multi-alloy casting and direct chill casting. In one example, the Al—Mg—Si alloy core layer 380 may be AA6013 and the Al—Mn alloy skin layers 370, 390 may be AA3003. Alternatively, the Al—Mg—Si alloy core layer 380 may be AA6013 and the Al—Mn alloy skin layers 370, 390 may be AA3104. In some instances, the Al—Mg—Si alloy core layer 380 includes one of 6xxx series aluminum alloys and the Al—Mn alloy skin layers 370, 390 include one of 3xxx series aluminum alloys.

In some embodiments, the total thickness T1, T2 of the composite sheets 320, 360 may be at least about 0.1 mm, or at least about 0.2 mm, or at least about 0.3 mm, or at least about 0.4 mm, or at least about 0.5 mm, or at least about 1 mm, or at least about 2 mm, or at least about 3 mm, or at least about 4 mm, or at least about 5 mm, or at least about 6 mm, or at least about 8 mm, or at least about 10 mm, or at least about 15 mm. In other embodiments, the total thickness T1, T2 of the composite sheets 320, 360 may be in the range of from about 0.1 mm to about 15 mm, or from about 0.5 mm to about 5 mm, or from about 1 mm to about 2 mm.

In one embodiment, the composite sheets 320, 360 may be produced in a T4 condition with a total thickness T1, T2 of about 1 mm, where T4 condition means a material that is solution heat treated and naturally aged. Solution heat treatment and natural aging will become more apparent in subsequent discussion below.

In one embodiment, the Al—Mg—Si alloy core layer 340 may be in the range of from about 60% to about 90% of the total thickness T1 of the composite sheet 320 while the Al—Mn alloy skin layer 330 may be in the range of from about 10% to about 40% of the total thickness T1 of the composite sheet 320. In the alternative, the Al—Mg—Si alloy core layer 340 and the Al—Mn alloy skin layer 330 may include other suitable thickness ranges.

In one example, the total thickness T1 of the composite sheet 320 may be about 1 mm with the Al—Mn alloy skin layer 330 at about 0.15 mm and the Al—Mg—Si alloy core layer 340 at about 0.85 mm. In another example, the total thickness T1 of the composite sheet 320 may be about 1 mm with the Al—Mn alloy skin layer 330 at about 0.2 mm and the Al—Mg—Si alloy core layer 340 at about 0.8 mm. In some instances, the total thickness T1 of the composite sheet 320 may be about 1 mm with the Al—Mn alloy skin layer 330 at about 0.25 mm and the Al—Mg—Si alloy core layer 340 at about 0.75 mm. In other instances, the total thickness T1 of the composite sheet 320 may be about 1 mm with the Al—Mn alloy skin layer 330 at about 0.3 mm and the Al—Mg—Si alloy core layer 340 at about 0.7 mm. In one example, the total thickness T1 of the composite sheet 320 may be about 6 mm with the Al—Mn alloy skin layer 330 at about 1.5 mm and the Al—Mg—Si alloy core layer 340 at about 4.5 mm.

In one embodiment, the Al—Mg—Si alloy core layer 380 may be in the range of from about 50% to about 80% of the total thickness T2 of the composite sheet 360, the first Al—Mn alloy skin layer 370 may be in the range of from about 10% to about 40% of the total thickness T2 of the composite sheet 360, and the second Al—Mn alloy skin layer 390 may be in the range of from about 0% to about 10% of the total thickness T2 of the composite sheet 360. In another embodiment, the Al—Mg—Si alloy core layer 380 may be in the range of from about 20% to about 80% of the total thickness T2 of the composite sheet 360 and each of the Al—Mn alloy skin layers 370, 390 may be in the range of from about 10% to about 40% of the total thickness T2 of the composite sheet 360 (not shown). In one embodiment, the first Al—Mn alloy skin layer 370 may be more suitable as an outer layer while the second Al—Mn alloy skin layer 390 may be more suitable as an inner layer. In the alternative, the Al—Mg—Si alloy core layer 380 and the Al—Mn alloy skin layers 370, 390 may include other suitable thickness ranges. In one example, the total thickness T2 of the composite sheet 360 may be about 1 mm with the first Al—Mn alloy skin layer 370 at about 0.25 mm, the Al—Mg—Si alloy core layer 380 at about 0.65 mm, and the second Al—Mn alloy skin layer 390 at about 0.1 mm.

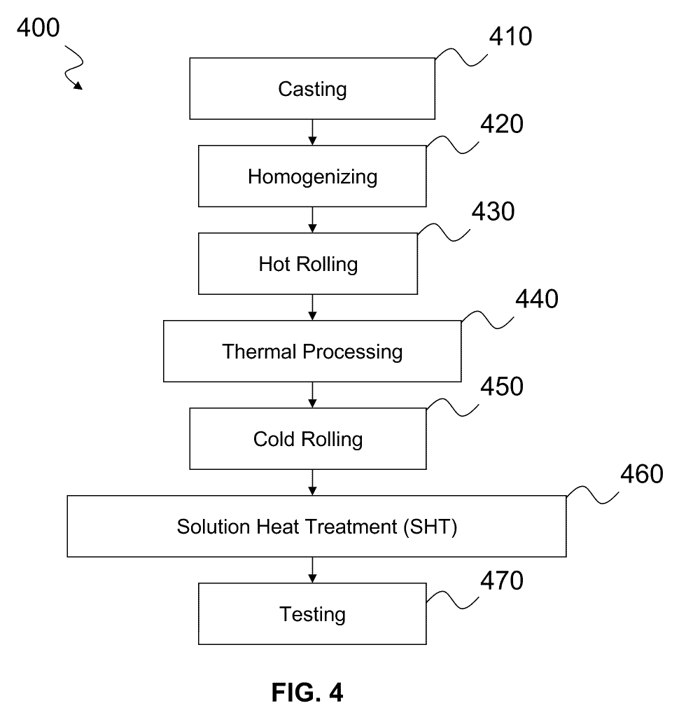

Reference is now made to FIG. 4 illustrating a process flow diagram 400 of the various steps of producing a composite sheet according to one embodiment of the present disclosure. In one embodiment, an ingot having at least one aluminum alloy may be produced by a casting step 410. The casting step 410 includes casting aluminum alloy ingots via multi-alloy casting or DC casting, among other suitable casting techniques. For example, a monolithic ingot (e.g., single layer) may be produced by casting a single aluminum alloy material. In other examples, a composite ingot (e.g., multi-alloy) may be produced by casting at least two aluminum alloys, where each aluminum alloy has a different chemical composition. In one embodiment, a composite ingot may be produced by separately casting at least two different aluminum alloy layers, and subsequently bringing and placing the aluminum alloy layers in physical contact with one another to from the composite ingot.

After the casting step 410, the monolithic or composite ingot may be subjected to a homogenizing step 420. In one embodiment, the homogenizing step 420 includes heating the ingot at temperatures ranging from about 540° C. to about 570° C. for about 4 hours. The homogenizing step 420 allows diffusion of species or other elements (e.g., magnesium, silicon) within the composite sheet. In some instances, the homogenizing step 420 may remove micro-segregations and enhance ingot uniformity.

The thickness of the ingot may subsequently be reduced to a desired gauge (e.g., sheet thickness) by a hot rolling step 430. In general, the hot rolling step 430 involves the use of heavy mechanical rollers that apply pressure to flatten or reduce the thickness of the ingot. Combined with high temperatures, the hot rolling step 430 may reduce the thickness of the ingot to the desired sheet thickness ranges rendering the sheet more suitable for subsequent processing steps. For example, an ingot having a thickness of about 304.8 mm (12 inches) may be hot rolled to a sheet having a thickness of about 3.4 mm (0.135 inch). At the beginning of the hot rolling step 430, the ingot may be at a temperature in the range of from about 500° C. to about 550° C. And at the conclusion of the hot rolling step 430, the sheet may be maintained at a temperature in the range of from about 250° C. to about 350° C. The combination of pressure from the mechanical rollers and the higher temperature may facilitate a nearly 10-fold reduction in ingot thickness to produced a monolithic or composite sheet with a thickness of not greater than about 15 mm or about 10 mm. In some instances, the sheet may be wound into a coil or unwound into sheet during the hot rolling step 430.

The monolithic or composite sheet may subsequently be subjected to a thermal processing step 440. In one embodiment, the thermal processing step 440 includes batch annealing (BA) the sheet at a temperature in the range of from about 420° C. to about 430° C. for about 60 minutes. In another embodiment, the thermal processing step 440 includes solution heat treatment (SHT) of the sheet at a temperature in the range of from about 540° C. to about 580° C. for about 5 minutes. The sheet may be wound into a coil or unwound into sheet during the thermal processing step 440.

After the thermal processing step 440, the thickness of the sheet may be further reduced by a cold rolling step 450. The cold rolling step 450 may be substantially similar to the hot rolling step 430 except that the cold rolling step 450 may be carried out at room or slightly elevated temperatures. In one embodiment, the cold rolling step 450 may further reduce the thickness of the monolithic or composite sheet from about 3.4 mm (0.135 inch) to about 1 mm (0.039 inch) translating to a thickness reduction of approximately 70%. In other embodiments, the cold rolling step 450 may reduce the thickness of the sheet by about 50% to about 60%, or by at least about 80%. In general, the thickness of the sheet may be reduced accordingly depending on the requirements of the automotive application. Like above, the sheet may be wound into a coil or unwound into sheet during the cold rolling step 450.

After the cold rolling step 450, the monolithic or composite sheet may be subjected to a solution heat treatment (SHT) step 460. In one embodiment, the SHT step 460 includes heating the sheet to a temperature in the range of from about 540° C. to about 580° C. for about 5 minutes. Furthermore, the SHT step 460 may include pre-aging the sheet after quenching. For example, after the high temperature treatment, the sheet may be subjected to a quenching process to a temperature in the range of from about 60° C. to about 100° C. followed by coiling of the sheet. The quenching process may be instantaneous and may involve quenching the sheet in air or water or both. In other instances, the quenching process may take place at room temperature. In one embodiment, after quenching to room temperature the process may include instantaneously exposing the sheet to a heating device such as infrared heating lamps or induction heating or an air furnace as the sheet is being coiled or uncoiled, whereby the exposure and subsequent coil cooling over about 1 hour to about 24 hours or longer may pre-age or alter the microstructure of the sheet. In one embodiment, after SHT, quenching to room temperature and coiling the coil, the coil can subsequently be heated in a furnace and allowed to cool inside the furnace or outside in ambient temperature.

After the SHT step 460, various tests may be carried out on the monolithic or composite sheet in a testing step 470. In some embodiment, the testing step 470 for characterizing the sheet may include hem performance, mechanical properties, shelf life, after paint-bake strength, dent resistance, surface quality, formability, corrosion resistance and grain size, among others.

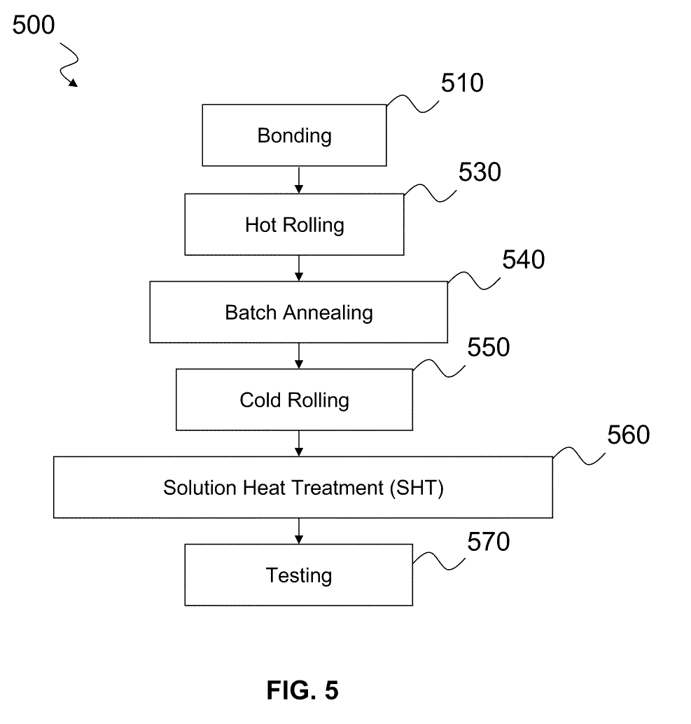

Reference is now made to FIG. 5 illustrating a process flow diagram 500 of the various steps of producing a composite sheet according to one embodiment of the present disclosure. In one embodiment, a composite ingot having at least two different aluminum alloy composition may be produced by a roll bonding step 510. For example, a first ingot may be produced by casting a first aluminum alloy material and a second ingot may be produced by casting a second aluminum alloy material. The two ingots may be roll bonded to each other by placing one ingot on top of another and applying mechanical forces to bring about bonding of the ingots. In one embodiment, a composite ingot may be produced by metallurgically bonding (e.g., lattice structures of the materials are forced into conformance with each other) at least two monolithic ingots to each other. In some instances, metallurgical bonding may utilize high pressure leading to deformation of the layers. In some embodiments, prior to the roll bonding step 510, each monolithic ingot may be homogenized by heating the ingot at temperatures ranging from about 540° C. to about 570° C. for about 4 hours.

After a composite ingot has been produced by a roll bonding step 510, the ingot may be subjected to hot rolling 530, batch annealing 540, cold rolling 550 and solution heat treatment 560 processes that are substantially similar to those described above. And like above, the resulting composite sheet may be evaluated by a testing step 570 to provide the necessary materials properties and characteristics.

One of the ways of characterizing an automotive panel is hemming performance. In general, an automotive panel may be associated with a hem rating based on its hemming performance, where the better the hemmability, the lower the likelihood of the automotive panel to suffer significant cracking when the automotive panel is bent and/or folded during the manufacture of such automotive panel.

Returning now to FIGS. 1-2, an outer panel 210 and an inner panel 230 may be hemmed together to produce an automotive panel 110. The hemming may result in the formation of a flange by bending and/or folding edges of each of the two panels 210, 230 together via suitable mechanical techniques. The hemming site may be evaluated and the automotive panel 110 may be assigned a hem rating. In one embodiment, an outer panel 210 and an inner panel 230 may be hemmed together to produce an automotive panel 110 by rope hem, relieved flat hem or flat hem, which may be considered one of the more challenging hemming techniques (e.g., more challenging than rope hem or relieved flat hem).

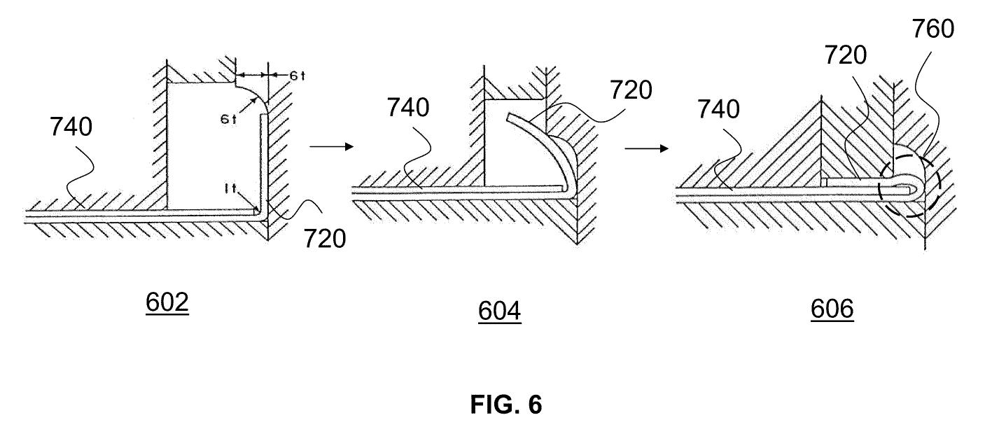

Reference is now made to FIG. 6 showing the processing steps for hemming an automotive panel. In step 602, an outer sheet 720 may be coupled to an inner sheet 740 after each sheet 720, 740 has been pre-strained (e.g., 7%, 11%, 15%). As shown, a portion of the outer sheet 720 may be bent by about 90 degrees with respect to the inner sheet 740. In one example, the thickness of the outer sheet 720 may be about 1 mm and the thickness of the inner sheet 740 may be about 1 mm. In another example, the thickness of the outer sheet 720 may be about 0.5 mm and the thickness of the inner sheet 740 may be about 0.5 mm. In other examples, the outer sheet 720 and the inner sheet 740 may include various thickness combinations. Labels “1t” and “6t” mean one time and six times the thickness of the sheet, respectively.

In step 604, additional forces may be applied to continue bending the outer sheet 720 by approximately another 90 degrees with respect to the inner sheet 740 with an overall bending angle of about 180 degrees. Bending of the outer and inner sheets 720, 740 may be accomplished by suitable mechanical devices. Subsequently, in step 606, a hemming site 760 may be formed after the outer sheet 720 has been substantially bent to wrap around a portion of the inner sheet 740.

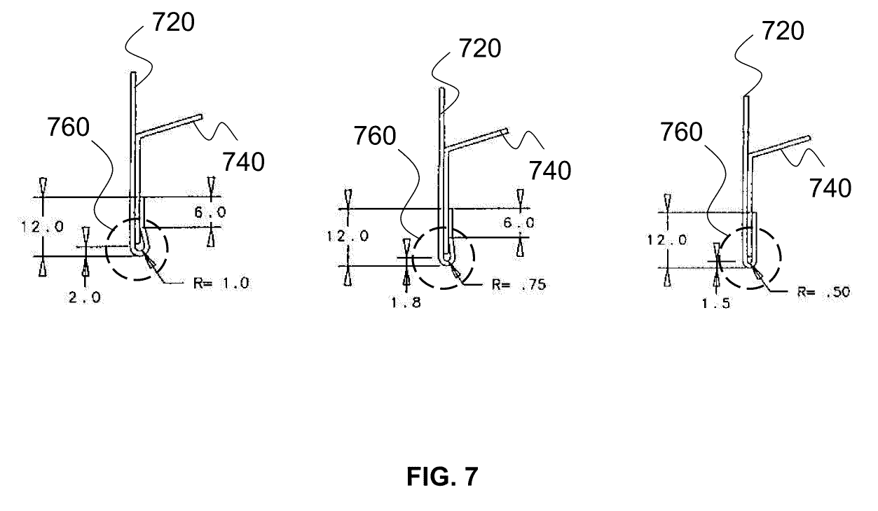

Reference is now made to FIG. 7 showing cross-sectional views of the various hems formed by bending an outer sheet 720 (e.g., outer layer) around an inner sheet 740 (e.g., inner layer) as substantially described above. The dimensions and units as shown are in millimeters (mm). As discussed above, the hemming process may occur by bending the outer sheet 720 over a portion of the inner sheet 740 by about 180 degrees with a bending radius R of 1.0 mm (rope hem), 0.75 mm (relieved flat hem) and 0.50 mm (flat hem) in accordance with ASTM E290-97A. In these examples, the radii are for a 1 mm thick sheet. In one embodiment, the joining of the outer sheet 720 and the inner sheet 740 may produce a composite sheet. In another embodiment, the outer sheet 720 may be an outer panel formed of a first composite and the inner sheet 740 may be an outer panel formed of a second composite, the two panels 720, 740 capable of being combined to produce an automotive panel such as a hood or a deck lid.

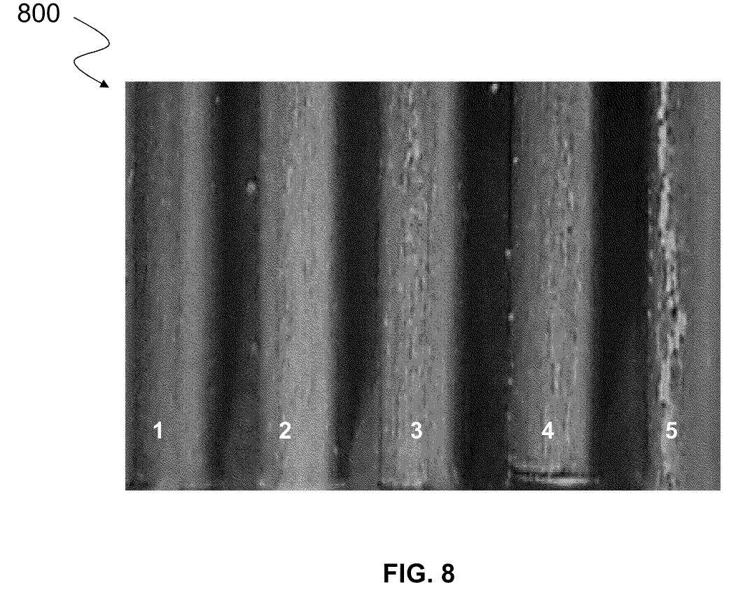

Reference is now made to FIG. 8 showing flat hem rating standards for side-by-side evaluation and comparison of a hemming site 760 of each specimen, and for assigning an associated flat hem rating. A score may be given to the specimens according to the following flat hem rating scale as shown in Table 1.

TABLE 1
Flat hem rating scale.

| | |
|---|---|
| 1 | No cracking (mild to moderate orange peel is acceptable) |
| 2 | Heavy orange peel |
| 3 | Cracks visible with 3X magnification |
| 4 | Cracks visible with naked eye |
| 5 | Fracture of continuous crack along the bend (e.g., hemming site) |

In general, flat hem rating of 1 is the best and flat hem rating of 5 is the worst. Orange peel is broadly understood as general grain roughening that occurs when materials with large grain sizes and/or specific orientations are deformed.

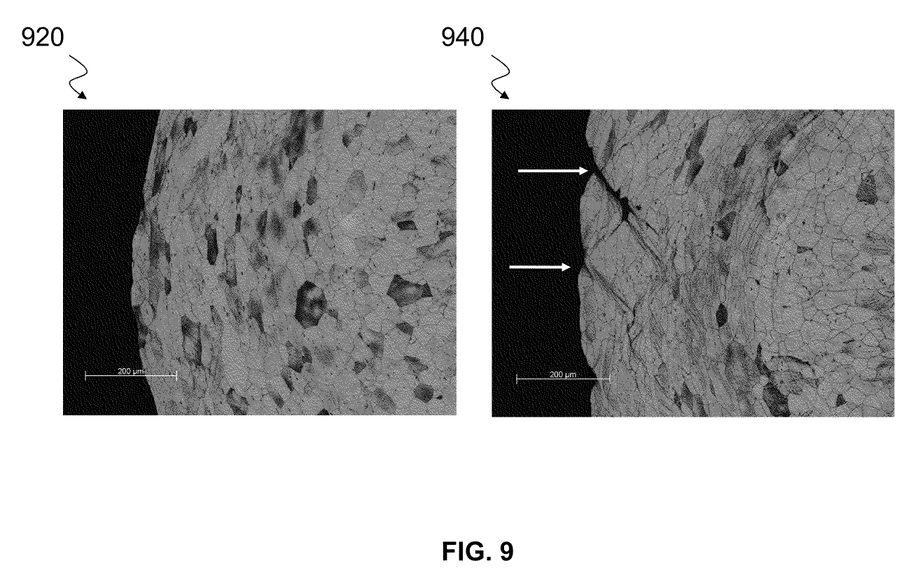

Reference is now made to FIG. 9 showing cross-sectional optical micrographs of hemming sites 760. A composite sheet with generally acceptable flat hem performance (e.g., acceptable flat hem rating) may exhibit minimal to no cracking on the surface as shown by the optical micrograph on the left 920, while a composite sheet with generally unacceptable flat hem performance (e.g., unacceptable flat hem rating) may exhibit substantial cracking on the surface (as illustrated by the arrows) as shown by the optical micrograph on the right 940. Specifically, generally acceptable optical micrographs 920 can be associated with flat hem ratings of 1 or 2 while generally unacceptable optical micrographs 940 can be associated with flat hem ratings of 3, 4 or 5.

Returning now to FIG. 3, in some embodiments, each composite sheet 320, 360 may be capable of achieving a flat hem rating of not worse than 5, or not worse than 4, or not worse than 3, or not worse than 2, or not worse than 1.

In one embodiment, flat hem rating can be measured longitudinal (e.g., 0 degrees, parallel) to the rolling direction of the composite sheet. The rolling direction is the direction in which the composite sheet is rolled through the mechanical rollers (e.g., hot rolling, cold rolling) during the manufacture of such composite sheet. In other instances, flat hem ratings may be measured transverse (90 degrees) or diagonal (45 degrees) to the rolling direction of the composite sheet. Flat hem ratings longitudinal to the rolling direction are generally worse than flat hem ratings transverse or diagonal to the rolling direction.

In some embodiments, a composite sheet 320, 360 may be pre-strained prior to flat hem testing. As used herein, “pre-strain” and the like means the amount of strain placed on a composite sheet, such as by a tensile tester (e.g., Instron tensile test machine). With pre-strain, a composite sheet may be put to plastic strain beyond the elastic limit of the material. In some instances, pre-strain may be reflective of the amount of strain that an automotive panel may be subjected to during the manufacture of such automotive panel.

In some instances, a composite sheet may be pre-strained at about 7%, or at about 11%, or at about 15%, prior to flat hem testing. In other instances, the composite sheet may be pre-strained to at least about 1%, or at least about 2%, or at least about 3%, or at least about 4%, or at least about 5%, or at least about 6%, or at least about 8%, or at least about 10%, or at least about 12%, or at least about 14%, or at least about 16%. Accordingly, the flat hem rating of a composite sheet may be measured after the composite sheet has been pre-strained to such pre-strain level.

In some embodiments, a composite sheet may be capable of achieving a flat hem rating of not worse than 5, or not worse than 4, or not worse than 3, or not worse than 2, or not worse than 1, at a pre-strain level of at least about 1%. In general, composite sheets with better flat hem ratings at higher pre-strain levels may be better at forming automotive panels with complex shapes and configurations.

In some embodiments, the flat hem ratings of a composite sheet may be measured at different time periods. As used herein, “time period” and the like means the amount of time that has elapsed, whether naturally or artificially, after a composite sheet has been produced by completing the solution heat treatment but prior to flat hem testing. For example, the flat hem rating of a composite sheet may be measured at time periods of at least about 7 days, or at least about 14 days, after the composite sheet has been produced. In other embodiments, the flat hem rating of the composite sheet may be measured at time periods of at least about 30 days, or at least about 45 days, or at least about 60 days, or at least about 75 days, or at least about 90 days, or other time periods, after the composite sheet has been produced.

In some embodiments, a composite sheet may be capable of achieving a flat hem rating of not worse than 5, or not worse than 4, or not worse than 3, or not worse than 2, or not worse than 1, at a time period of at least about 7 days. In other embodiments, a composite sheet may be capable of achieving a flat hem rating of not worse than 5, or not worse than 4, or not worse than 3, or not worse than 2, or not worse than 1, at a time period of at least about 14 days, or at least about 21 days, or at least about 30 days, or at least about 60 days, or at least about 90 days.

In general, composite sheets with better flat hem ratings after longer time periods may have better shelf life. In other words, the composite sheet need not be formed into an automotive panel immediately after the production of such composite sheet, but may instead remain on the shelf for the measured time period prior to being used to form the automotive panel. The hemming performance of an automotive panel generally decreases with increasing shelf life (e.g., flat hem ratings of 1 after about 30 days and 3 after at about 90 days). This decrease in flat hem rating may be due to changes in material properties with time.

As used herein, “shelf life” and the like means the length of time (e.g., age, time period) over which a composite sheet continues to meet all applicable specification requirements such as flat hem rating. For example, the shelf life of a composite sheet may be associated with natural aging, which includes changes, if any, to the composite sheet after exposing the composite sheet to normal environmental conditions for a predetermined time period. In one embodiment, shelf life studies via natural aging experiments may be carried out by initially measuring the flat hem rating of a composite sheet at about 30 days after production, and repeating the same measurement at about 90 days after production, where the composite sheet has been exposed to and maintained at ambient room condition (e.g., sitting on a shelf in a room) during the two measurements. In some instances, natural aging may occur to a composite sheet during, for example, storing of the composite sheet after production but prior to the composite sheet being shipped to a stamping plant, the amount of time spent by the composite sheet in the stamping plant, and storing of the composite sheet after the stamping plant but prior to the stamped composite sheet being shipped to an assembly plant.

In addition to flat hem rating, mechanical properties of a composite sheet, including such properties as tensile yield strength (TYS), ultimate tensile strength (UTS), total and uniform elongation (%), among others, may be measured. In some embodiments, the mechanical properties may be measured transverse to the rolling direction of the composite sheet. In other embodiments, the mechanical properties can be determined longitudinal or diagonal to the rolling direction of the composite sheet. Mechanical properties transverse to the rolling direction are generally worse than mechanical properties longitudinal or diagonal to the rolling direction.

In some embodiments, a composite sheet according to one embodiment of the present disclosure may achieve TYS of at least about 100 MPa, or at least about 110 MPa, or at least about 120 MPa, or at least about 130 MPa, or at least about 140 MPa, or at least about 150 MPa. In other embodiments, a composite sheet according to one embodiment of the present disclosure may achieve UTS of at least about 200 MPa, or at least about 210 MPa, or at least about 220 MPa, or at least about 230 MPa, or at least about 240 MPa, or at least about 250 MPa, or at least about 260 MPa, or at least about 270 MPa, or at least about 280 MPa, or at least about 290 MPa, or at least about 300 MPa. In some instances, a composite sheet according to one embodiment of the present disclosure may achieve elongations (e.g., total, uniform) of at least about 10%, or at least about 12%, or at least about 14%, or at least about 16%, or at least about 17%, or at least about 18%, or at least about 19%, or at least about 20%, or at least about 21%, or at least about 22%, or at least about 23%, or at least about 24%, or at least about 25%.

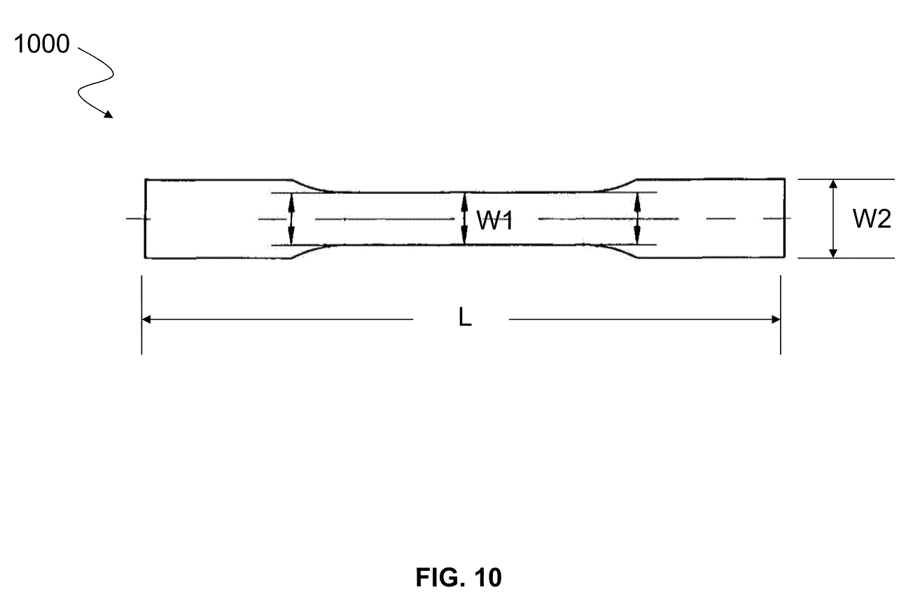

For measuring the mechanical properties of a composite sheet, standard tensile test specimens may be machined and tested per ASTM Methods B557 and E8. In one embodiment, the standard tensile test specimen may be substantially similar to a “dog-bone” shaped specimen 1000 as shown in FIG. 10. In one example, length (L) of the specimen 1000 may be in the range of from about 228.6 mm to about 279.4 mm (9 inches to 11 inches), thickness may be not greater than about 12.7 mm (0.5 inch), and width varying from about 12.7 mm (0.5 inch) (W1) to about 19.1 mm (0.75 inch) (W2). In other examples, the specimen 900 can come in a variety of shapes and sizes.

Like flat hem ratings, in some embodiments, mechanical properties of a composite sheet may be measured at different time periods similar to those described above. Furthermore, the mechanical properties of a composite sheet according to the present disclosure may maintain acceptable mechanical characteristics and properties with relatively long shelf life. In other words, the strength and elongation of the composite sheet do not significantly decrease after extended time periods or natural aging.

Another way of characterizing an automotive panel is paint bake (PB) strength, which may be indicative of its dent resistance or the ability of the automotive panel to avoid and/or minimize dents and dings while in service. In one embodiment, an automotive panel may be subjected to a PB treatment to simulate actual processing condition associated with the automotive panel. In some instances, the PB treatment may also be referred to as artificial aging. For example, the automotive panel may be thermally treated to increase its PB strength and dent resistance. In these instances, the outer and inner panels of the automotive panel may be treated separately or in combination. In general, the greater the PB strength of a composite sheet after a PB process (e.g., tensile yield strength and ultimate tensile strength after paint bake), the greater the ability of the composite sheet to withstand dents and dings while in service. Different automobile manufacturers may have different levels of minimum PB strength standards for various automotive applications.

In one example, artificial aging includes subjecting a composite sheet to thermal treatment cycles to simulate process conditions. In one embodiment, a PB cycle may include a combination of pre-straining (e.g., at 2%) and heating (e.g., at about 170° C. for about 20 minutes). In other instances, the PB cycle may include treatment cycles at different temperatures and/or time periods, with or without pre-straining. The composite sheet may subsequently be air cooled to room temperature and its mechanical properties may be tested. In some embodiments, the mechanical properties to be tested after a PB cycle include the likes of tensile yield strength (TYS), ultimate tensile strength (UTS) and elongation, among others. In some instances, the TYS and UTS of the composite sheet after a PB cycle may be referred to as after PB strength.

In some embodiments, a composite sheet according to one embodiment of the present disclosure may achieve after PB strength of at least about 150 MPa, or at least about 180 MPa, or at least about 190 MPa, or at least about 200 MPa, or at least about 220 MPa, or at least about 240 MPa, or at least about 260 MPa, or at least about 280 MPa, or at least about 300 MPa, or at least about 310 MPa, or at least about 320 MPa, or at least about 330 MPa, or at least about 340 MPa, or at least about 350 MPa. In other embodiments, a composite sheet according to one embodiment of the present disclosure may achieve elongations (e.g., total, uniform), after a PB cycle, of at least about 10%, or at least about 12%, or at least about 14%, or at least about 16%, or at least about 17%, or at least about 18%, or at least about 19%, or at least about 20%, or at least about 21%, or at least about 22%, or at least about 23%, or at least about 24%, or at least about 25%.

As discussed above, natural aging includes maintaining a composite sheet at room temperature for a desired time period or duration. In some instances, natural aging may occur to a material causing changes in performance (e.g., flat hem ratings) or mechanical properties (e.g., strength of material before and after thermal treatment), among other properties. For instance, 6xxx series aluminum alloys may have relatively short shelf life as the materials tend to naturally age with time. In other words, the flat hem performance a 6xxx series aluminum alloy may decrease with increasing shelf life. Thus, upon hemming of the 6xxx series aluminum alloy into an automotive panel, cracks or fractures and the like, may result.

Another way of characterizing an automotive panel is limiting dome height, which may be used to assess the formability of the automotive panel. As used herein, “limiting dome height” refers to a maximum height of a dome formed by a composite sheet for assessing, at least in part, the formability of the composite sheet. In one embodiment, limiting dome height may be determined by rigidly clamping and stretching a composite sheet to the point of plastic instability (e.g., fracture) using a hemispherical-shaped structure such as a dome. In one example, the stretching may be carried out by mechanical force. The point at which the composite sheet fractures defines the limiting dome height and the maximum load that the composite sheet may sustain. In general, the greater the limiting dome height, the better the formability of the material.

As used herein, “formability” and the like means the relative ease with which a composite sheet can be shaped through plastic deformation. For example, the formability of an automotive panel fabricated of a composite sheet may be determined, at least in part, by the limiting dome height and in some instances, elongation (higher elongation percentages may indicate better formability) of the composite sheet, among other properties. In general, the better the formability of the composite sheet, the easier it is to manipulate the composite sheet into a desired shape. The extent to which the composite sheet can be stretched before failure occurs may also be known as the formability or forming limit.

In some embodiments, the composite sheet may achieve a limiting dome height of at least about 5 mm, or at least about 10 mm, or at least about 15 mm, or at least about 20 mm, or at least about 21 mm, or at least about 22 mm, or at least about 23 mm, or at least about 24 mm, or at least about 25 mm, or at least about 26 mm, or at least about 27 mm, or at least about 28 mm, or at least about 29 mm, or at least about 30 mm.

In some embodiments, the formability of an automotive panel may be influenced by the strain-hardening coefficient (n) and the width-to-thickness strain ratio (R). The strain-hardening coefficient (n) and the width-to-thickness strain ratio (R) are dimensionless constants used to measure a material's formability, where the larger the value of the strain-hardening coefficient (n) and the width-to-thickness strain ratio (R), the better the formability of the material. In addition, higher n and R values may indicate better resistance against thinning, wrinkling and other artifacts.

In some embodiments, a composite sheet according to one embodiment of the present disclosure may achieve smaller grain sizes, which may enhance the composite sheet's formability, hemming performance and surface appearance or quality, among other attributes.

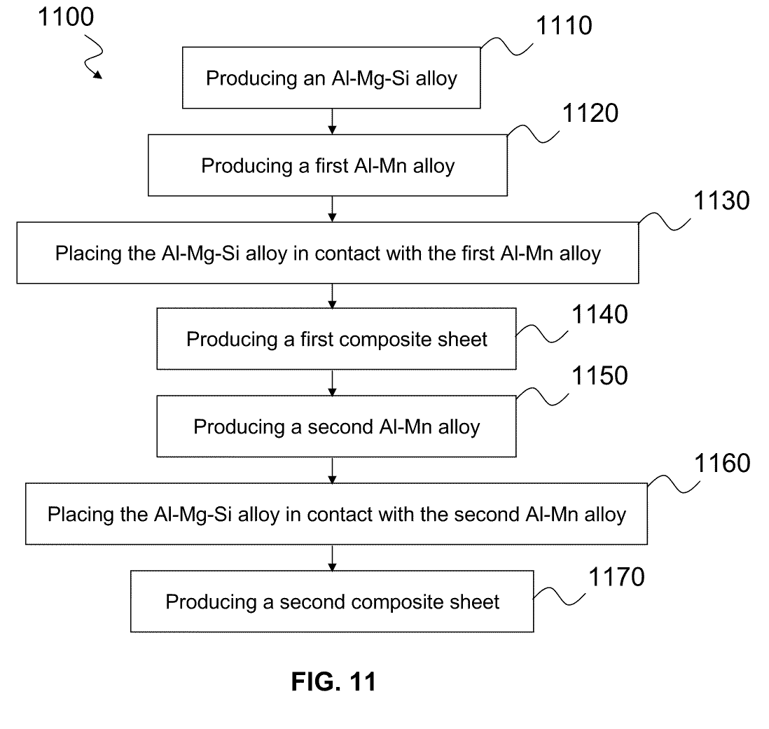

Reference is now made to FIG. 11 illustrating a process flow diagram 1100 of the various steps of manufacturing a composite sheet according to one embodiment of the present disclosure. For example, a method of manufacturing a composite sheet includes producing an Al—Mg—Si alloy 1110. In some instances, the Al—Mg—Si alloy may be a 6xxx series aluminum alloy and can be produced by at least one of roll bonding, multi-alloy casting and direct-chill casting as described herein, among other techniques. Subsequently, the method includes producing a first Al—Mn alloy 1120, which can be a 3xxx series aluminum alloy. Like the Al—Mg—Si alloy, the Al—Mn alloy can be produced by at least one of roll bonding, multi-alloy casting and direct-chill casting as described herein, among other techniques. Although the process flow shows the Al—Mg—Si alloy being produced ahead of the Al—Mn alloy, it will be appreciated that the Al—Mn alloy can be produced ahead of the Al—Mg—Si. Alternatively, the two alloys may be produced concomitantly or simultaneously.

In one embodiment, the method includes placing a first surface of the Al—Mg—Si alloy in physical contact with a first surface of the first Al—Mn alloy 1130. The placing step 1130 results in producing a bi-layer composite sheet 1140, which can achieve a flat hem rating of not worse than 3, or not worse than 2, or not worse than 1.

Additionally, the method of manufacturing a composite sheet further includes producing a second Al—Mn alloy step 1150. The method of producing the second Al—Mn alloy can be substantially similar in all respect to the first Al—Mn alloy with the exception that the alloys need not have the same chemical composition and/or thickness. Next, the method may include a second placing step 1160 whereby a second surface of the Al—Mg—Si alloy can be placed in contact with a first surface of the second Al—Mn alloy. In one embodiment, the first and second surfaces of the Al—Mg—Si alloy are opposite one another. The placing step 1160 results in producing a tri-layer composite sheet 1170, which like the bi-layer composite sheet, can achieve a flat hem rating of not worse than 3, or not worse than 2, or not worse than 1.

The following examples demonstrate the feasibility of a multi-alloy composite sheet as an automotive panel.

### Example 1

### Tri-Layer Composite with AA3104 and AA6013 Aluminum Alloys

A tri-layer composite sheet 360 having a cross-section substantially similar to that shown in FIG. 3 can be produced by casting using the process flow as shown in FIG. 4. Specifically, the tri-layer composite sheet 360 can be produced by multi-alloy casting an AA3104 Al—Mn alloy first skin layer 370, an AA6013 Al—Mg—Si alloy core layer 380, and another AA3104 Al—Mn alloy as second skin layer 390. The AA3104 and AA6013 aluminum alloys have the chemical composition (in weight percentages) as shown in Table 2.

TABLE 2
Chemical composition (in wt. %) of AA3104 and AA6103 aluminum alloys.

| Alloy | Si | Fe | Cu | Mn | Mg | Al |
|---|---|---|---|---|---|---|
| AA3104 | 0.22-0.30 | 0.52-0.58 | 0.15-0.20 | 0.93-0.97 | 1.17-1.26 | Remainder |
| AA6013 | 0.65-0.75 | 0.25-0.29 | 0.85-1.04 | 0.30-0.32 | 0.90-1.04 | Remainder |

The resulting composite ingot of AA3104 and AA6013 aluminum alloys has a width of about 0.4 meter (16 inches), a length of about 1.4 meters (55 inches), and a thickness of about 0.3 meter (12 inches), and can be homogenized at about 560° C. for about 4 hours. Hot rolling of the composite ingot results in the production of a composite sheet having a thickness of about 3.4 mm. A first sample (Example 1A) is subjected to batch annealing at a temperature of about 425° C. for about 60 minutes while a second sample (Example 1B) is subjected to solution heat treatment at a temperature of about 570° C. for about 5 minutes. The thickness of both samples are further reduced by cold rolling to T4 condition with a total thickness T2 of about 1 mm. The thickness of the AA3104 first skin layer 370 is about 25% (0.25 mm) of the total thickness T2 of the composite sheet 360, the thickness of the AA6013 core layer 380 is about 65% (0.65 mm) of the total thickness T2 of the composite sheet 360, and the thickness of the AA3104 second skin layer 390 is about 10% (0.10 mm) of the total thickness T2 of the composite sheet 360. Both samples are further subjected to a solution heat treatment process at a temperature of about 570° C. for about 5 minutes.

The tri-layer composite sheets 360 are evaluated against a control sample of a monolithic sheet of AA6022 Al—Mg—Si alloy, which can be produced by direct chill casting using the process flow as shown in FIG. 4. Specifically, the AA6022 ingot can be homogenized at about 550° C. for about 4 hours, followed by hot rolling to a thickness of about 3.4 mm. The resulting AA6022 monolithic sheet is subsequently batch annealed at a temperature of about 425° C. for about 60 minutes, and cold rolled to T4 condition to a thickness of about 1 mm. The AA6022 control sample is further solution heat treated at a temperature of about 550° C. for about 5 minutes.

The material properties and performance of the tri-layer composite sheets 360 and the AA6022 control sample are shown in Table 3. All measurements are tested after 30 days of natural aging and in the orientation transverse to the rolling direction with the exception of the flat hem rating, which is tested in the orientation longitudinal to the rolling direction. The flat hem ratings are measured at three different levels of pre-strain (7%, 11%, 15%). Mechanical properties including tensile yield strength (TYS), ultimate tensile strength (UTS) and elongation (%) designated by a dagger symbol (†) are measured after a paint bake cycle consisting of pre-straining the sheet at 2% and heating at about 170° C. for about 20 minutes.

TABLE 3
Performance of the tri-layer AA3104/AA6013/AA3104
composite sheet.

| Material Property | 6022-1 | Example 1A | Example 1B |
|---|---|---|---|
| Thermal Processing | Anneal | Anneal | SHT |
| Flat Hem at 7%/11%/15% | 3/3/4 | 1/1/1 | 1/1/1 |
| TYS (MPa) | 123.4 | 115.1 | 117.2 |
| UTS (MPa) | 231.7 | 246.1 | 246.8 |
| Total Elongation (%) | 24.2 | 18.6 | 21.3 |
| Uniform Elongation (%) | 21.8 | 18.5 | 20.3 |
| TYS^{†} (MPa) | 231.0 | 195.8 | 197.9 |
| UTS^{†} (MPa) | 297.2 | 278.5 | 282.0 |
| Elongation^{†} (%) | 20.5 | 20.3 | 18.0 |
| n Value | 0.259 | 0.267 | 0.262 |
| R Value | 0.637 | 0.663 | 0.641 |

As shown in Table 3, the hemming performance of the tri-layer composite sheets 360 (Examples 1A and 1B) are superior to the AA6022 control sample. Specifically, both tri-layer composite sheets 360 are able to sustain good flat hem ratings across all three pre-strain levels (e.g., 1's vs. 3's and 4's at 7%, 11% and 15% pre-strain).

In addition, the mechanical properties (e.g., TYS, UTS and elongation) of the tri-layer composite sheets 360 (Examples 1A and 1B) are substantially comparable to those of the AA6022 control sample. Specifically, tensile yield strength (e.g., average 116 MPa vs. 123 MPa), ultimate tensile strength (e.g., average 246 MPa vs. 232 MPa), and elongation (e.g., average 20% vs. average 23%) are substantially similar between the tri-layer composite sheets 360 and the AA6022 control sample.

Furthermore, the tri-layer composite sheets 360 are able to maintain the mechanical performance after a paint-bake treatment. Specifically, tensile yield strength (e.g., average 197 MPa vs. 231 MPa), ultimate tensile strength (e.g., average 280 MPa vs. 297 MPa), and elongation (e.g., average 19% vs. 21%), after the paint-bake cycle, are substantially comparable between the tri-layer composite sheets 360 and the AA6022 control sample. In general, each tri-layer composite sheet 360 meets a minimum after PB strength of at least about 190 MPa.

The tri-layer composite sheets 360 can also achieve comparable if not enhanced formability as automotive panels relative to the AA6022 control sample. Specifically, the tri-layer composite sheets 360 have similar if not slightly better n (e.g., average 0.265 vs. 0.259) and R values (e.g., average 0.652 vs. 0.637) in comparison to the AA6022 control sample.

The material properties and performance of the tri-layer composite sheets 360 and the AA6022 control sample, after 3 months of natural aging, are shown in Table 4. The measurements are similar in all respect to those of Table 3 with the exception of the time period.

TABLE 4
Performance of the tri-layer composite sheets after
3 months natural aging.

| Material Property | 6022-1 | Example 1A | Example 1B |
|---|---|---|---|
| Thermal Processing | Anneal | Anneal | SHT |
| Flat Hem at 7%/11%/15% | 2/3/4 | 1/2/2 | 1/1/1 |
| TYS (MPa) | 141.3 | 117.9 | 117.2 |
| UTS (MPa) | 249.6 | 255.1 | 246.8 |
| Total Elongation (%) | 21.8 | 24.1 | 19.5 |
| Uniform Elongation (%) | 20.9 | 20.9 | 19.4 |
| TYS^{†} (MPa) | 231.0 | 194.4 | 192.4 |
| UTS^{†} (MPa) | 297.9 | 281.3 | 276.5 |
| Elongation^{†} (%) | 20.0 | 22.0 | 17.5 |
| n Value | 0.238 | 0.263 | 0.263 |
| R Value | 0.654 | 0.738 | 0.544 |

As shown in Table 4, the hemming performance of the tri-layer composite sheets 360 (Examples 1A and 1B) remain relatively unchanged after 3 months of natural aging, and maintains superior performance to the AA6022 control sample. Specifically, both tri-layer composite sheets 360 are still able to sustain good flat hem ratings across all three pre-strain levels even after 3 months of natural aging (e.g., 1's and 2's at 7%, 11% and 15% pre-strain), and are still better than the AA6022 control sample (e.g., 2, 3 and 4 at 7%, 11% and 15% pre-strain, respectively).

In addition, the mechanical properties (e.g., TYS, UTS and elongation) of the tri-layer composite sheets 360 (Examples 1A and 1B) remain substantially comparable to those of the AA6022 control sample after 3 months. Specifically, tensile yield strength (e.g., average 118 MPa vs. 141 MPa), ultimate tensile strength (e.g., average 251 MPa vs. 250 MPa), and elongation (e.g., average 22% vs. average 21%) are substantially similar between the tri-layer composite sheets 360 and the AA6022 control sample. Also, the mechanical properties of both tri-layer composite sheets 360 did not sustain substantial degradation after 3 months natural aging (e.g., TYS: 115.1 MPa to 117.9 MPa (Example 1A), 117.2 MPa to 117.2 MPa (Example 1B); UTS: 246.1 MPa to 255.1 MPa (Example 1A), 246.8 MPa to 246.8 MPa (Example 1B)).

Furthermore, the tri-layer composite sheets 360 are able to maintain the mechanical after paint-bake performance after 3 months. Specifically, the after paint-bake tensile yield strength (e.g., average 193 MPa vs. 231 MPa), ultimate tensile strength (e.g., average 279 MPa vs. 298 MPa), and elongation (e.g., average 20% vs. 21%), after 3 months, are substantially comparable between the tri-layer composite sheets 360 and the AA6022 control sample. Like above, the mechanical properties of the tri-layer composite sheets 360 did not sustain substantial degradation after 3 months natural aging (e.g., TYS: 195.8 MPa to 194.4 MPa (Example 1A), 197.9 MPa to 192.4 MPa (Example 1B); UTS: 278.5 MPa to 281.3 MPa (Example 1A), 282.0 MPa to 276.5 MPa (Example 1B)). In general, each tri-layer composite sheet 360 meets a minimum after PB strength of at least about 190 MPa.

The tri-layer composite sheets 360 can also achieve comparable if not enhanced formability as automotive panels relative to the AA6022 control sample after 3 months. Specifically, the tri-layer composite sheets 360 have similar if not slightly better n (e.g., average 0.263 vs. 0.238) and R values (e.g., average 0.641 vs. 0.654) in comparison to the AA6022 control sample after 3 months. Furthermore, the n and R values did not sustain substantial degradation after 3 months natural aging (e.g., n value: 0.267 to 0.263 (Example 1A), 0.262 to 0.263 (Example 1B); R value: 0.663 to 0.738 (Example 1A), 0.641 to 0.544 (Example 1B)).

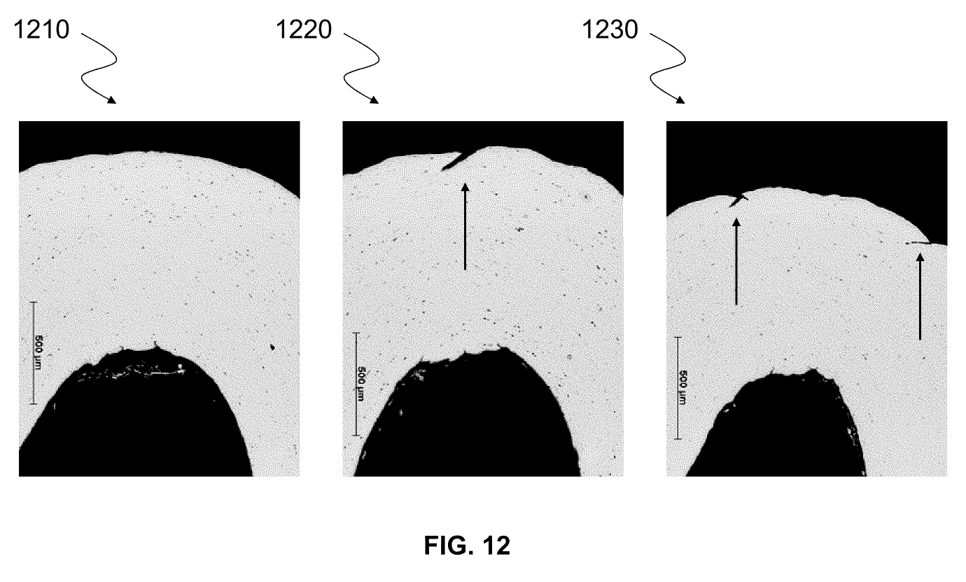

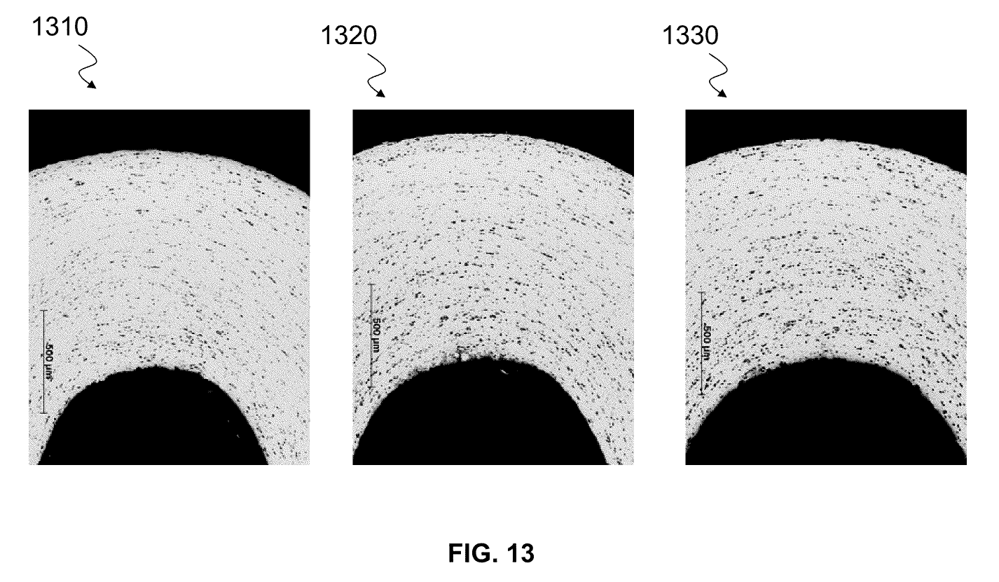

References is now made to FIGS. 12-13 showing cross-sectional optical micrographs of hemming sites of 6022-1 and Example 1A after 3 months natural aging. Specifically, the optical micrographs in FIG. 12 are directed to the AA6022 control sample while the optical micrographs in FIG. 13 are directed to the tri-layer composite sheet 360 (Example 1A). As shown in FIG. 12, the optical micrograph on the left 1210 is for an AA6022 control sample that has been pre-strained at 7% and has a flat hem rating of 2, the optical micrograph in the middle 1220 has been pre-strained at 11% and has a flat hem rating of 3, and the optical micrograph on the right 1230 has been pre-strained at 15% with a flat hem rating of 4. Similarly, as shown in FIG. 13, the optical micrograph on the left 1310 is for a tri-layer composite sheet 360 (Example 1A) that has been pre-strained at 7% and has a flat hem rating of 1, the optical micrograph in the middle 1320 has been pre-strained at 11% with a flat hem rating of 2, and the optical micrograph on the right 1330 has been pre-strained at 15% with a flat hem rating of 2.

In short, the flat hem ratings of the tri-layer composite 360 are better than the AA6022 control sample at each pre-strain level (e.g., 7%, 11% and 15%) where no cracks are visible. In contrast, other than sample 1210 at the 7% pre-strain, both 11% and 15% pre-strain samples 1220, 1230 showed cracking (as illustrated by the arrows) on the surfaces of the hemming sites. Furthermore, the tri-layer composite 360 is able to maintain minimal to nearly zero cracking across the three different pre-strain levels 1310, 1320, 1330 (e.g., from 7% to 11% to 15%) as substantially shown in FIG. 13, in contrast to the incremental cracking experienced by the AA6022 control samples 1210, 1220, 1230 (e.g., from 7% to 11% to 15%, zero cracks to one crack to two cracks), thus confirming the tri-layer composite sheets 360 having better flat hem ratings than the AA6022 control sample.

### Example 2

### Bi-Layer Composite with AA3104 and AA6013 Aluminum Alloys

A bi-layer composite sheet 320 having a cross-section substantially similar to that shown in FIG. 3 can be produced by casting using the process flow as shown in FIG. 4. Specifically, the bi-layer composite sheet 320 can be produced by multi-alloy casting an AA3104 Al—Mn alloy skin layer 330 and an AA6013 Al—Mg—Si alloy core layer 340, and placing the two layers 330, 340 in physical contact with each other. The AA3104 and AA6013 aluminum alloys have the chemical composition (in weight percentages) as shown in Table 5.

TABLE 5
Chemical composition (in wt. %) of AA3104 and AA6103 aluminum alloys.

| Alloy | Si | Fe | Cu | Mn | Mg | Al |
|---|---|---|---|---|---|---|
| AA3104 | 0.22-0.24 | 0.52-0.57 | 0.15-0.20 | 0.93-1.01 | 1.17-1.22 | Remainder |
| AA6013 | 0.65-0.71 | 0.20-0.30 | 0.85-0.91 | 0.30-0.32 | 0.90-0.98 | Remainder |

Like above, the resulting composite ingot of AA3104 and AA6013 aluminum alloys has a width of about 0.4 meter (16 inches), a length of about 1.4 meters (55 inches), and a thickness of about 0.3 meter (12 inches), and can be homogenized at about 560° C. for about 4 hours. Hot rolling of the composite ingot results in the production of a composite sheet having a thickness of about 3.4 mm. A first sample (Example 2A) is subjected to batch annealing at a temperature of about 425° C. for about 60 minutes while a second sample (Example 2B) is subjected to solution heat treatment at a temperature of about 570° C. for about 5 minutes. The thicknesses of both samples are further reduced by cold rolling to T4 condition with a total thickness T1 of about 1 mm.

The thickness of the AA3104 skin layer 330 is about 25% (0.25 mm) of the total thickness T1 of the composite sheet 320 while the thickness of the AA6013 core layer 340 is about 75% (0.75 mm) of the total thickness T1 of the composite sheet 320. Both samples are further subjected to a solution heat treatment process at a temperature of about 570° C. for about 5 minutes. Like above, the bi-layer composite sheets 320 are evaluated against a control sample of a monolithic sheet of AA6022 Al—Mg—Si alloy, which can be produced by the method described above.

The material properties and performance of the bi-layer composite sheets 320 and the AA6022 control sample are shown in Table 6, where the measurements are similar to those described above.

TABLE 6
Performance of the bi-layer AA3104/AA6013 composite sheet.

| Material Property | 6022-2 | Example 2A | Example 2B |
|---|---|---|---|
| Thermal Processing | Anneal | Anneal | SHT |
| Flat Hem at 7%/11%/15% | 3/3/4 | 3/3/4 | 1/1/2 |
| TYS (MPa) | 123.4 | 146.2 | 148.9 |
| UTS (MPa) | 231.7 | 289.6 | 300.6 |
| Total Elongation (%) | 24.2 | 21.3 | 25.2 |
| Uniform Elongation (%) | 21.8 | 19.6 | 21.2 |
| TYS^{†} (MPa) | 231.0 | 252.3 | 258.6 |
| UTS^{†} (MPa) | 297.2 | 339.2 | 349.6 |
| Elongation^{†} (%) | 20.5 | 18.0 | 20.5 |
| n Value | 0.259 | 0.260 | 0.262 |
| R Value | 0.637 | 0.610 | 0.576 |

As shown in Table 6, although the hemming performance of one of the bi-layer composite sheets 320 (Example 2A) is comparable to that of the AA6022 control sample (e.g., 3's and 4's), the hemming performance of the other bi-layer composite sheet 320 (Example 2B) has demonstrated superior flat hem ratings (e.g., 1's and 2's vs. 3's and 4's) compared to the AA6022 control sample and across all pre-strain levels (e.g., 7%, 11% and 15%).

In addition, the mechanical properties (e.g., TYS, UTS and elongation) of the bi-layer composite sheets 320 (Examples 2A and 2B) are substantially better than those of the AA6022 control sample. Specifically, the tensile yield strength (e.g., average 148 MPa vs. 123 MPa) and the ultimate tensile strength (e.g., average 295 MPa vs. 232 MPa) of the bi-layer composite sheets 320 have achieved improvements of at least about 15% and at least about 30%, respectively, versus the AA6022 control sample. The bi-layer composite sheets 320 are further able to maintain comparable elongation (e.g., average 22% vs. average 23%) versus the AA6022 control sample. In general, each bi-layer composite sheet 320 meets a minimum after PB strength of at least about 190 MPa.

Furthermore, the bi-layer composite sheets 320 are able to demonstrate improved mechanical performance after a paint-bake treatment. Specifically, tensile yield strength (e.g., average 255 MPa vs. 231 MPa), ultimate tensile strength (e.g., average 344 MPa vs. 297 MPa), and elongation (e.g., average 19% vs. 20%), after the paint-bake cycle, are substantially comparable (and in some instances slightly better) between the bi-layer composite sheets 320 and the AA6022 control sample.

The bi-layer composite sheets 320 can also achieve comparable formability as automotive panels relative to the AA6022 control sample. Specifically, the bi-layer composite sheets 320 have substantially similar n (e.g., average 0.261 vs. 0.259) and R values (e.g., average 0.593 vs. 0.637) in comparison to the AA6022 control sample.

The material properties and performance of the bi-layer composite sheets 320 and the AA6022 control sample, after 3 months of natural aging, are shown in Table 7. The measurements are similar in all respect to those of Table 6 with the exception of the time period.

TABLE 7
Performance of the bi-layer composite sheets after 3 months of
natural aging.

| Material Property | 6022-2 | Example 2A | Example 2B |
|---|---|---|---|
| Thermal Processing | Anneal | Anneal | SHT |
| Flat Hem at 7%/11%/15% | 2/3/4 | 2/2/2 | 2/2/3 |
| TYS (MPa) | 141.3 | 151.7 | 152.4 |
| UTS (MPa) | 249.6 | 295.8 | 303.4 |
| Total Elongation (%) | 21.8 | 18.4 | 24.1 |
| Uniform Elongation (%) | 20.9 | 18.2 | 18.3 |
| TYS^{†} (MPa) | 231.0 | 257.2 | 259.2 |
| UTS^{†} (MPa) | 297.9 | 344.0 | 348.2 |
| Elongation^{†} (%) | 20.0 | 19.0 | 20.0 |
| n Value | 0.238 | 0.258 | 0.261 |
| R Value | 0.654 | 0.557 | 0.570 |

As shown in Table 7, the hemming performance of the bi-layer composite sheets 320 (Examples 2A and 2B) remain relatively unchanged after 3 months of natural aging, and maintains superior performance to the AA6022 control sample. Specifically, both bi-layer composite sheets 320 are still able to sustain good flat hem ratings across all three pre-strain levels even after 3 months of natural aging (e.g., 2's and 3's at 7%, 11% and 15% pre-strain), and are still better than the AA6022 control sample (e.g., 2, 3 and 4 at 7%, 11% and 15% pre-strain, respectively).

In addition, the mechanical properties (e.g., TYS, UTS and elongation) of the bi-layer composite sheets 320 (Examples 2A and 2B) remain superior than those of the AA6022 control sample after 3 months. Specifically, tensile yield strength (e.g., average 152 MPa vs. 141 MPa), ultimate tensile strength (e.g., average 300 MPa vs. 250 MPa), and elongation (e.g., average 20% vs. average 21%) of the bi-layer composite sheets 320 are substantially better than the AA6022 control sample. Also, the mechanical properties of both bi-layer composite sheets 320 did not sustain substantial degradation after 3 months natural aging (e.g., TYS: 146.2 MPa to 151.7 MPa (Example 2A), 148.9 MPa to 152.4 MPa (Example 2B); UTS: 289.6 MPa to 295.8 MPa (Example 2A), 300.6 MPa to 303.4 MPa (Example 2B)).

Furthermore, the bi-layer composite sheets 320 are able to maintain superior mechanical after paint-bake performance after 3 months. Specifically, the after paint-bake tensile yield strength (e.g., average 258 MPa vs. 231 MPa), ultimate tensile strength (e.g., average 346 MPa vs. 298 MPa), and elongation (e.g., average 20% vs. 20%), after 3 months, of the bi-layer composite sheets 320 are better than the AA6022 control sample. Like above, the mechanical properties of the bi-layer composite sheets 320 did not sustain substantial degradation after 3 months natural aging (e.g., TYS: 252.3 MPa to 257.2 MPa (Example 2A), 258.6 MPa to 259.2 MPa (Example 2B); UTS: 339.2 MPa to 344.0 MPa (Example 2A), 349.6 MPa to 348.2 MPa (Example 2B)). In general, each bi-layer composite sheet 320 meets a minimum after PB strength of at least about 190 MPa.

The bi-layer composite sheets 320 can also achieve comparable if not enhanced formability as automotive panels relative to the AA6022 control sample after 3 months. Specifically, the bi-layer composite sheets 320 have similar if not slightly better n (e.g., average 0.260 vs. 0.238) and R values (e.g., average 0.564 vs. 0.654) in comparison to the AA6022 control sample after 3 months. Furthermore, the n and R values did not sustain substantial degradation after 3 months natural aging (e.g., n value: 0.260 to 0.258 (Example 2A), 0.262 to 0.261 (Example 2B); R value: 0.610 to 0.557 (Example 2A), 0.576 to 0.570 (Example 2B)).

### Example 3

### Bilayer Composite with AA3003 and AA6013 Aluminum Alloys

A bi-layer composite sheet 320 having a cross-section substantially similar to that shown in FIG. 3 can be produced by bonding using the process flow as shown in FIG. 5. Specifically, the bi-layer composite sheet 320 can be produced by roll bonding an AA3003 Al—Mn alloy skin layer 330 to an AA6013 Al—Mg—Si alloy core layer 340. The AA3003 and AA6013 aluminum alloys have the chemical composition (in weight percentages) as shown in Table 8.

TABLE 8
Chemical composition (in wt. %) of AA3003 and AA6103 alloys.

| Alloy | Si | Fe | Cu | Mn | Mg | Cr | Ti | Al |
|---|---|---|---|---|---|---|---|---|
| AA3003 | 0.20 | 0.49 | 0.11 | 1.10 | 0.01 | 0.006 | 0.03 | Remainder |
| AA6013 | 0.63 | 0.27 | 0.85 | 0.30 | 0.87 | 0.033 | 0.02 | Remainder |

Like above, the resulting composite ingot of AA3003 and AA6013 aluminum alloys can be hot rolled to a thickness of about 3.4 mm, batch annealed at a temperature of about 425° C. for about 60 minutes, and further reduced by cold rolling to T4 condition to a total thickness T1 of about 1 mm. The thickness of the AA3003 skin layer 330 is about 20% (0.20 mm) of the total thickness T1 of the composite sheet 320 while the thickness of the AA6013 core layer 340 is about 80% (0.80 mm) of the total thickness T1 of the composite sheet 320. The bi-layer composite sheet 320 is further subjected to a solution heat treatment process at a temperature of about 570° C. for about 5 minutes. Like above, the bi-layer composite sheet 320 can be evaluated against a control sample of a monolithic sheet of AA6022 Al—Mg—Si alloy, which can be produced by the method described above.

The material properties and performance of the bi-layer composite sheets 320 and the AA6022 control sample are shown in Table 9, where the measurements are similar to those described above.

TABLE 9
Performance of the bi-layer AA3003/AA6013 composite sheet.

| Material | 6022-3 | Example 3 |
|---|---|---|
| Flat Hem at 7%/11%/15% | 2/3/4 | 1/1/1 |
| TYS (MPa) | 106.2 | 113.8 |
| UTS (MPa) | 222.7 | 244.8 |
| Total Elongation (%) | 25.1 | 25.5 |
| Uniform Elongation (%) | 22.2 | 20.6 |
| TYS^{†} (MPa) | 199.0 | 198.0 |
| Limiting Dome Height (mm) | 25.0 | 24.1 |
| n Value | 0.276 | 0.271 |
| R Value | 0.713 | 0.676 |

As shown in Table 9, the hemming performance of the bi-layer composite sheet 320 is superior to the AA6022 control sample. Specifically, the bi-layer composite sheet 320 is able to sustain good flat hem ratings across all three pre-strain levels (e.g., 1's vs. 2-4 at 7%, 11% and 15% pre-strain).

In addition, the mechanical properties (e.g., TYS, UTS and elongation) of the bi-layer composite sheet 320 are substantially better than those of the AA6022 control sample. Specifically, tensile yield strength (e.g., 114 MPa vs. 106 MPa), ultimate tensile strength (e.g., average 245 MPa vs. 223 MPa), and elongation (e.g., average 23% vs. average 24%) of the bi-layer composite sheet 320 are better than the AA6022 control sample. Furthermore, the bi-layer composite sheet 320 is able to demonstrate comparable mechanical performance to that of the AA6022 control sample (e.g., 198 MPa vs. 199 MPa) after a paint-bake treatment.

The bi-layer composite sheet 320 can also achieve comparable formability as automotive panels relative to the AA6022 control sample. Specifically, the bi-layer composite sheet 320 has substantially similar limiting dome height (e.g., 24.1 mm vs. 25.0 mm), and similar n (e.g., 0.271 vs. 0.276) and R values (e.g., 0.676 vs. 0.713) in comparison to the AA6022 control sample.

The presently disclosed composite sheets may satisfy the needs of automotive manufacturers for closure panels, including the likes of a hood, decklid or a door. The composite sheet may be formed of multi-alloys capable of achieving improved formability and greater dent resistance after thermal exposure (paint bake), among other properties and characteristics. As such, the composite sheet may satisfy the forming and strength requirements for exterior body panel as well as other structural applications. Furthermore, the composite sheet may be artificially aged to increase its strength for higher dent resistance of the formed part similar to or better than traditionally used alloys.

Although the multi-alloy composite sheets and methods of manufacturing the same have been described in detail with reference to several embodiments, additional variations and modifications exist within the scope and spirit of the disclosure.

What is claimed is:

1. A composite sheet comprising:
an Al—Mg—Si alloy layer; and
an Al—Mn alloy layer coupled to at least one surface of the Al—Mg—Si alloy layer, wherein the composite sheet achieves a flat hem rating of not worse than 3.

2. The composite sheet of claim 1, wherein the composite sheet achieves a flat hem rating of not worse than 2.

3. The composite sheet of claim 1, wherein the Al—Mg—Si alloy is a 6xxx series aluminum alloy, and wherein the Al—Mn alloy is a 3xxx series aluminum alloy.

4. The composite sheet of claim 1, wherein the Al—Mg—Si alloy layer has a thickness in the range of from about 60% to about 90% of the total thickness of the composite sheet, and wherein the Al—Mn alloy layer has a thickness in the range of from about 10% to about 40% of the total thickness of the composite sheet.

5. The composite sheet of claim 1, wherein the flat hem rating is measured at a pre-strain level of at least about 1%.

6. The composite sheet of claim 1, wherein the flat hem rating is measured at a time period of at least about 7 days.

7. The composite sheet of claim 1, wherein the composite sheet achieves a yield strength of at least about 190 MPa after a paint bake cycle.

8. The composite sheet of claim 1, wherein the composite sheet achieves a limiting dome height of at least about 20 mm.

9. A composite sheet comprising:
an Al—Mg—Si alloy layer;
a first Al—Mn alloy layer coupled to a first surface of the Al—Mg—Si alloy layer; and
a second Al—Mn alloy layer coupled to a second surface of the Al—Mg—Si alloy layer, wherein the second surface is opposite the first surface, and wherein the composite sheet achieves a flat hem rating of not worse than 3.

10. The composite sheet of claim 9, wherein the composite sheet achieves a flat hem rating of not worse than 2.

11. The composite sheet of claim 9, wherein the Al—Mg—Si alloy is a 6xxx series aluminum alloy, and wherein each of the first Al—Mn alloy and the second Al—Mn alloy is a 3xxx series aluminum alloy.

12. The composite sheet of claim 9, wherein the Al—Mg—Si alloy layer has a thickness in the range of from about 50% to about 80% of the total thickness of the composite sheet, wherein the first Al—Mn alloy layer has a thickness in the range of from about 10% to about 40% of the total thickness of the composite sheet, and wherein the second Al—Mn alloy layer has a thickness in the range of from about 0% to about 10% of the total thickness of the composite sheet.

13. The composite sheet of claim 9, wherein the flat hem rating is measured at a pre-strain level of at least about 1%.

14. The composite sheet of claim 9, wherein the flat hem rating is measured at a time period of at least about 7 days.

15. The composite sheet of claim 9, wherein the composite sheet achieves a yield strength of at least about 190 MPa after a paint bake cycle.

16. A method comprising:
(a) producing an Al—Mg—Si alloy layer;
(b) producing an Al—Mn alloy layer; and
(c) placing a first surface of the Al—Mg—Si alloy layer in contact with a first surface of the Al—Mn alloy layer, wherein the placing step (c) includes producing a composite sheet having a flat hem rating of not worse than 3.

17. The method of claim 16, wherein the Al—Mg—Si alloy is a 6xxx series aluminum alloy, and wherein the Al—Mn alloy is a 3xxx series aluminum alloy.

18. The method of claim 16, wherein the placing step (c) includes at least one of roll bonding, multi-alloy casting and direct chill casting.

19. The method of claim 16, wherein the Al—Mn alloy layer is a first Al—Mn alloy layer, and wherein the composite sheet is a first composite sheet, further comprising:
(d) producing a second Al—Mn alloy layer; and
(e) placing a second surface of the Al—Mg—Si alloy layer in contact with a first surface of the second Al—Mn alloy layer, wherein the second surface of the Al—Mg—Si alloy layer is opposite the first surface of the Al—Mg—Si alloy layer, and wherein the placing step (e) includes producing a second composite sheet having a flat hem rating of not worse than 3.

20. The method of claim 16, wherein the second Al—Mn alloy is a 3xxx series aluminum alloy, and wherein the placing step (e) includes at least one of roll bonding, multi-alloy casting and direct chill casting.
